(19) United States
(12) Patent Application Publication
(10) Pub. No.: US 2015/0103090 A1
(43) Pub. Date: Apr. 16, 2015

(54) KEYER TOOL

(71) Applicant: Apple Inc., Cupertino, CA (US)

(72) Inventors: Daniel Pettigrew, Pacific Palisades, CA (US); Andrew E. Bryant, Los Gatos, CA (US)

(73) Assignee: Apple Inc., Cupertino, CA (US)

(21) Appl. No.: 14/053,586

(22) Filed: Oct. 14, 2013

(51) Int. Cl. H04N 9/64; G06K 9/20; G06T 11/00

(52) U.S. Cl. CPC H04N 9/646; G06T 11/001; G06K 9/2081; G06T 2207/10024; G06T 2207/20172
USPC 345/590; 345/157; 345/173

(57) ABSTRACT

A method that generates a chromakey image and then generates a color corrected, spill suppressed chromakey image. The application identifies the edges of non-transparent objects in the image and determines whether the edges are dark. If the edges are dark, then the application subtracts the color corrected, spill suppressed chromakey image from the chromakey image. The subtraction generates an outline image that includes a bright outline of the objects with the dark edges, while the objects themselves in the outline image are almost entirely black. The application then darkens, based on the outline image, the pixels of the color corrected, spill suppressed chromakey image.

### BACKGROUND

In greenscreen/bluescreen photography, objects (including people) are placed in front of a green/blue background and photographed to create a source image or a source video clip. The image or video clip is then digitally altered to create a greenscreen/bluescreen image or greenscreen/bluescreen video clip. In a greenscreen/bluescreen image or greenscreen/bluescreen video clip, pixels of the image/clip that are the same color as the green/blue background are identified as being transparent when the image or video is layered over another image (a “background image”) or video clip (a “background video clip”).

By rendering the green/blue background transparent, the objects are shown against any desired background image or background video clip. However, in some cases, when the objects captured in an image are dark objects and the pixels of the image that are the same color as a greenscreen/bluescreen are made transparent, a tinted “outline” of bright green/blue remains around the edges of the objects. In some cases a green/blue tint remains on the object. The outline and tint are sometimes referred to as “spill”. When the greenscreen/bluescreen image or greenscreen/bluescreen video clip is played over a background image or background video clip, the outline makes it jarringly obvious that the object was not actually filmed against the background.

Another issue in greenscreen/bluescreen photography is that the green/blue background against which objects are photographed may include multiple shades of the background color. For example, the background may include a highlight with brighter and or more saturated shades or a shadow with darker and/or less saturated shades of the primary shade of the background. When the primary shade of the background is rendered transparent in a greenscreen/bluescreen image overlaid on a background, the highlights and shadows may be partially or fully visible over the background image.

### SUMMARY

In greenscreen photography, a visible side effect of capturing a dark-edged object against a greenscreen is that the edges of the object will be surrounded by bright green light. This bright green light is not close enough to the predominant color of the greenscreen to be rendered fully transparent when the image and/or video editing application generates the greenscreen image. Another visual effect is that the object will be tinted with green light reflected off the background. This bright outline and green tint is sometimes called “spill” or “spillover”. Video/Image editing applications of some embodiments use various techniques to suppress this spill.

In some embodiments, the application generates a greenscreen image and then generates a color corrected, spill suppressed greenscreen image. The application identifies the edges of non-transparent objects in the image and determines whether the edges are dark. If the edges are dark, then the application subtracts the color corrected, spill suppressed greenscreen image from the greenscreen image. The result of the subtraction is an outline image that includes a bright outline of the objects with the dark edges, while the objects themselves turned almost entirely black. The application then darkens the pixels of the color corrected, spill suppressed greenscreen image based on the outline image.

Separately from the outline suppression techniques, some embodiments provide an application with a tool for selecting pixel colors to be rendered transparent in a greenscreen image. The application of some embodiments provides a tool that allows a user to select a set of pixels in a source image or in a greenscreen image. The tool then renders the selected pixels transparent in the greenscreen image. In some embodiments, the tool receives the selection by a single operation of selecting a location on an image and moving over the image (e.g., a single click-and-drag command). The application of such embodiments then sets the colors of the selected pixels to be completely transparent. The application of some embodiments also generates or modifies a key that determines which pixel colors are rendered as transparent in the greenscreen image and which pixel colors are rendered as partially transparent in the greenscreen image.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE FIGURES

The novel features of the invention are set forth in the appended claims. However, for purpose of explanation, several embodiments of the invention are set forth in the following figures.

FIG. 1 illustrates the application of an outline suppression technique of some embodiments.

FIG. 2 illustrates the same application as FIG. 1 using positive captured images instead of negatives.

FIG. 3 illustrates a technique for removing undesired pixel colors from a greenscreen image.

FIG. 4 conceptually illustrates a process of some embodiments for suppressing a bright outline around a dark-edged object in a greenscreen image.

FIG. 5 conceptually illustrates how the edges are determined to be dark in some embodiments.

FIG. 6 illustrates an example of a transition from a source image to a greenscreen image and visually demonstrates how obvious a bright outline is against a dark edge.

FIG. 7 illustrates the generation of an outline image.

FIG. 8 illustrates examples of composite images generated with various techniques.

FIG. 9 conceptually illustrates a process of some embodiments for removing undesired pixel colors in a greenscreen image.

FIGS. 10A illustrates a user interface receiving the beginning of a selection of an irregular area in some embodiments.

FIG. 10B illustrates the user interface receiving the end of the selection of an irregular area.

FIG. 11 illustrates a larger view of color selection scopes from FIGS. 10A and 10B.

FIG. 12 is an example of an architecture of a mobile computing device that implements the application of some embodiments.

FIG. 13 conceptually illustrates another example of an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to be identical to the embodiments set forth and that the invention may be practiced without some of the specific details and examples discussed. It will be clear to one of ordinary skill in the art that various controls depicted in the figures are examples of controls provided for reasons of clarity. Other embodiments may use other controls while remaining within the scope of the present embodiment. For example, a control depicted herein as a hardware control may be provided as a software icon control in some embodiments, or vice versa. Similarly, the embodiments are not limited to the various indicators depicted in the figures. For example, the color wheels depicted in some figures could be replaced by hexagons, or by other indicators of colors.

Outline suppression techniques are used to reduce the brightness of an outline around dark objects in a greenscreen image in some embodiments. In some embodiments, the outline suppression technique is applied only to greenscreen images and not to bluescreen images.

However, in other embodiments, the technique is applied to bluescreen images as well as greenscreen images. For the sake of brevity, this application uses the term “greenscreen” and “greenscreen image” rather than “greenscreen/bluescreen” or “chromakey”. However, in some embodiments, techniques and processes applied to a greenscreen image are equally applicable to bluescreen images or other chromakey images. Therefore one of ordinary skill in the art will understand that where the terms “greenscreen” and “greenscreen image” are used herein in reference to some embodiments, the terms “bluescreen” and “bluescreen image” or “chromakey” and “chromakey image” could be substituted unless otherwise specified. Similarly, while the description below refers to images, the image editing application in some embodiments is also a video editing application and uses the same methods and techniques on greenscreen/bluescreen/chromakey video images as well or instead of non-motion greenscreen/bluescreen/chromakey images.

The term “greenscreen image” as used herein refers to digital data that contains both image color component information and opacity information. The image color component information identifies colors of the objects in the image in a particular colorspace (e.g., RGB, YC_{b}Cᵣ, HSL, or HSV colorspace). The image data is divided into separate pixels, each pixel having a set of color data. In addition to the image color component data, each pixel of a greenscreen image also includes an opacity value (sometimes called an “alpha” value). As used herein, the alpha values will be assumed to range from 0 (completely transparent) to 1 (completely opaque). However, one of ordinary skill in the art will understand that different alpha scales are used in different embodiments. In some embodiments, a transparency value is used instead of an opacity value. A pixel with a higher transparency value is more transparent than a pixel with a lower transparency value. A pixel with a higher opacity value, on the other hand, is less transparent than a pixel with a lower opacity value.

An application of some embodiments is able to provide a color representation of a greenscreen image that displays the color components of each pixel, including the color components of the pixels designated as transparent. An application of some embodiments is able to provide a representation that visually depicts the opacity value of all pixels in an image (e.g., by displaying different opacities as different shades of black, white, and gray). Other embodiments provide other ways of displaying the opacity (or transparency) value. However, by its nature, transparency (or partial transparency) of a pixel itself can only be depicted in relation to another pixel color (e.g., black, white, blue, red, etc.) that is seen (or partially seen) through the transparent (or partially transparent) pixel. Accordingly, the application of some embodiments demonstrates transparency of various pixels by displaying greenscreen images against a background (e.g., a black background or a background image). Thus, even when there is no background image, the application of some embodiments provides a default background in order to display a composite image to represent the greenscreen image. That is, these applications do not display the greenscreen image itself, but rather a composite of the greenscreen image and a background color or background image. Accordingly, as described herein, images that depict the greenscreen image against a default (e.g., black) background are called “composite images”. However other descriptions of such images (greenscreen images against a default background) might describe the displayed images as “greenscreen images”.

The background image comprises a set of pixels over which the pixels of the greenscreen image are imposed. An image/video editing application combines each background pixel with the corresponding pixel of the greenscreen image to form a pixel of a composite image. The color of a composite image pixel is a weighted average of the colors of the background image pixel and the greenscreen image pixel. The weight in the weighted average is determined by the alpha value of the greenscreen image pixel. When the alpha value of a greenscreen image pixel is one (i.e., fully opaque), then the corresponding composite image pixel will be entirely the color of the greenscreen image pixel. When the alpha value of a greenscreen image pixel is zero, then the corresponding composite image pixel will be entirely the color of the background image pixel. When the alpha value is between one and zero, the alpha value in some embodiments represents the fraction of the composite image pixel values derived from the greenscreen image. For example, if the alpha value is ¼ then the composite pixel will get ¼ of its color from the greenscreen image and ¾ of its color from the background image. In some embodiments, when a specific background image is not provided, a greenscreen image is shown on a default background (e.g., a black background).

A greenscreen image is generated from a source image in which the background is green. The pixels that are the predominant shade(s) of green are then set as transparent in the greenscreen image derived from the source image. In some embodiments, shades of green near the predominant shade of green in colorspace (i.e., having similar color component values) are designated as partially transparent (e.g., given an alpha value which is low, but not zero). As described herein, the set of color values that are completely or partially transparent are referred to as a “key”. Pixels that have color component values within the key are rendered as fully or partially transparent. Pixels that have color component values that are not within the key are rendered as opaque. The following subsections A and B each describes an example to show how the issues of outline suppression and color removal are handled in an application of some embodiments.

A visible side effect of capturing an image of a dark-edged object against a greenscreen is that the edges of the object will be surrounded by bright green light. This bright green light is not close enough to the predominant color of the greenscreen to be rendered fully transparent when the video editing application generates the greenscreen image. Another visual effect is that the object will be tinted with green light reflected off the background. This bright outline and green tint is sometimes called “spill” or “spillover”. Image editing applications of some embodiments use various techniques to suppress this spill.

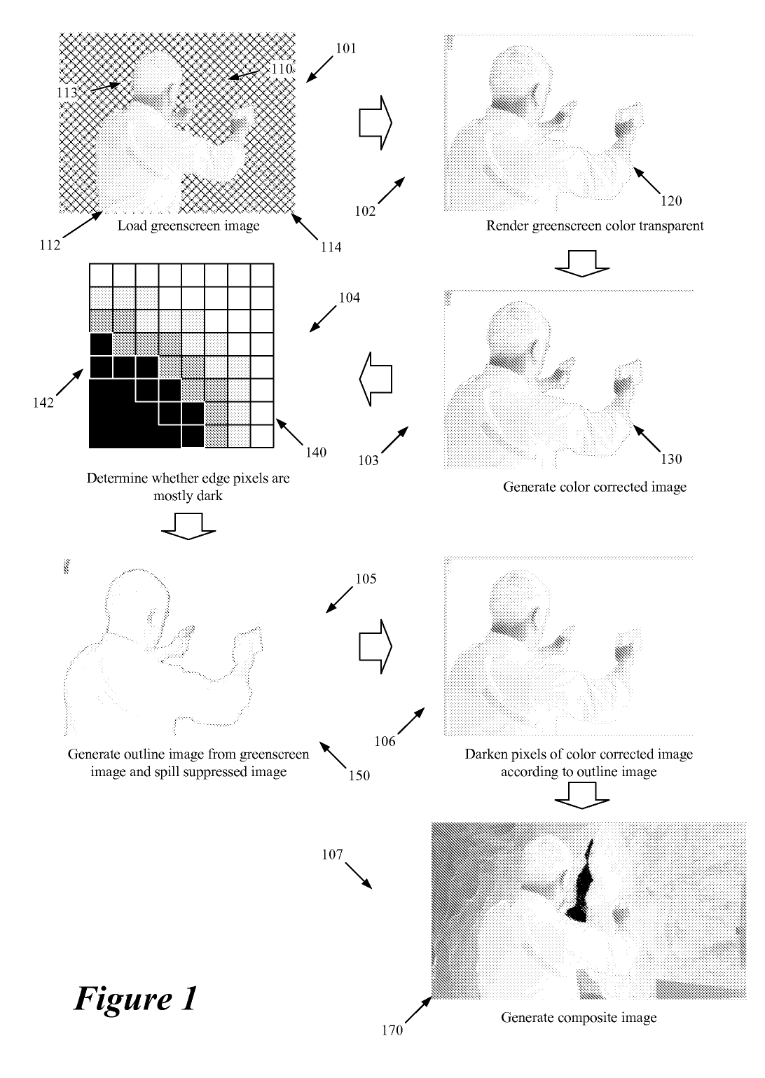

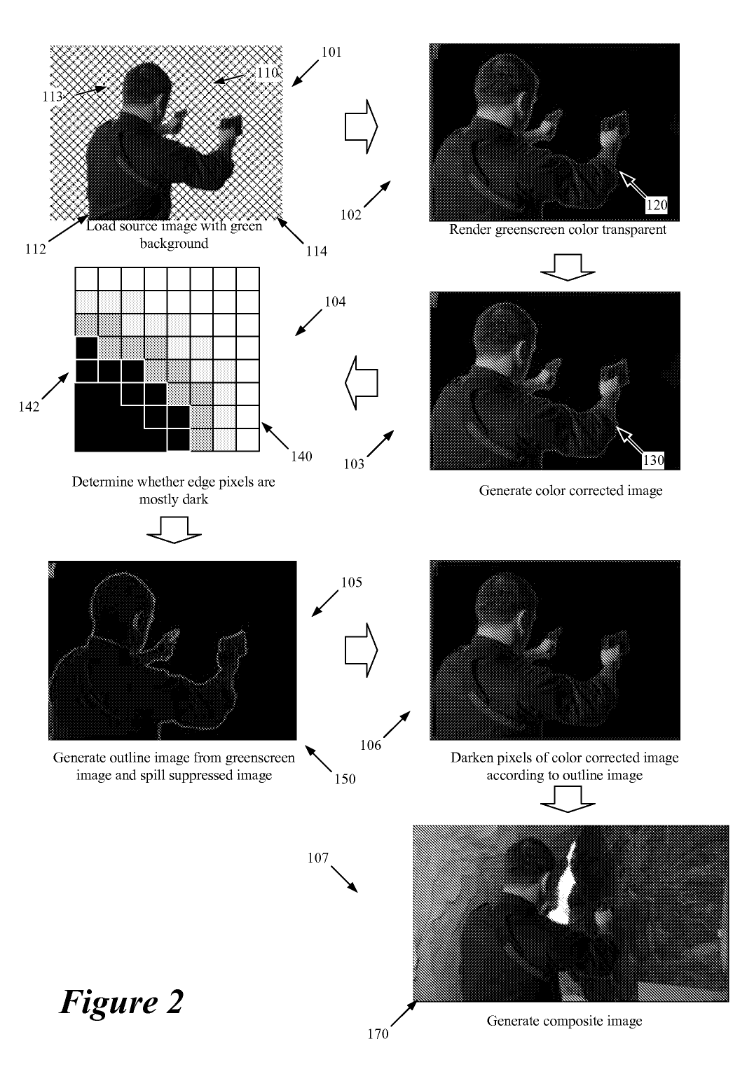

FIG. 1 illustrates the application of an outline suppression technique of some embodiments. The figure is shown in seven stages 101-107. In the figure, negatives of captured images are used because the positive versions of the images include dark areas and slight variations in dark objects are more difficult to see than slight variations in light objects. Additionally, on a printed page, a dark outline on a light background is easier to see than a light outline on a dark background. To reduce confusion when describing an object in the negative captured image as “black” when the object is shown as white in FIG. 1, FIG. 2 illustrates the same application as FIG. 1 using positive captured images. Each numbered item in FIG. 1 is also shown in FIG. 2, therefore the description of FIG. 1 provides the description of FIG. 2, with the exception that captured images have the opposite brightness in FIG. 2 from what they do in FIG. 1.

In the first stage 101, an image viewing, organizing, and editing application of some embodiments loads an image of a man 110 in a black shirt 112 (shown as white in the negative in the figure) with dark hair 113 against a green background 114. Background 114 is illustrated as diagonal crosshatching. In stage 102, the application then renders transparent the parts of the image that are the same shade(s) of green as the green background 114. In this stage 102, the application generates a greenscreen image (i.e., an image with the green pixels designated as transparent). In stage 102, the application places the greenscreen image against a black background (shown as white in the negative) in the figure. The man 110 can be seen in stage 102 to have a visible dark outline 120 (i.e., a bright green outline in the non-negative image). In stage 103, the application generates a color corrected, spill suppressed greenscreen image and places it against a black background. The color corrected, spill suppressed greenscreen image is similar to the greenscreen image, except that the green tint has been removed. In some embodiments, the application renders the green tint neutral in chroma (i.e., makes the green pixels gray). An incidental effect of removing the green tint converts the outline 120 to a dimmer outline 130 that is gray instead of green.

Because the bright outline is more obvious around an object with a dark edge, some embodiments determine whether the edges of the objects in the image are dark before suppressing the light outline. In some embodiments, the application identifies the edges of objects in the greenscreen image by determining the opacity of the pixels in the greenscreen image. In some embodiments, opaque pixels that are next to pixels that are transparent or partially transparent are identified as edge pixels. Stage 104 shows an opacity representation 140 of a small part of the hair 113 of the man 110. The opacity representation 140 shows opaque pixels as black, fully transparent pixels as white, and partially transparent pixels as gray. In this case, the black pixels with white outlines 142 that are next to the gray pixels are identified as the edge pixels of the object. In some embodiments, the application determines whether the edge pixels 142 of the objects in the image are dark. In some such embodiments, if more than a threshold fraction (e.g., ½) of the edge pixels are darker than a threshold darkness level (e.g., less than 20% of maximum brightness), then the image is identified as having dark edges.

In some embodiments, when a threshold fraction of the edges in an image are dark (e.g., when more than 50% of the total edge length in the image is dark), the application generates an outline image by subtracting the color corrected, spill suppressed greenscreen image from the greenscreen image. In other embodiments, when at least one object in a greenscreen image is identified as having a dark edge, the application generates an outline image by subtracting the color corrected, spill suppressed greenscreen image from the greenscreen image. Most of the bright pixels after the subtraction are the pixels in the outline. In stage 105, an outline image 150 is shown. The outline image includes few details of the man 110 (the darker portions of the image are largely concealed). The brightest pixels (shown as darkest in the negative of stage 105) are the pixels of the outline.

The application of some embodiments then uses the outline image 150 as a basis for darkening the pixels of the color corrected, spill suppressed greenscreen image shown in stage 103. The brighter a pixel is in the outline image 150, the more the brightness of the corresponding pixel in the color corrected, spill suppressed greenscreen image will be reduced. In stage 106, an outline suppressed, color corrected, spill suppressed greenscreen image is shown against a black background (white in the negative of the figure). In stage 106, the resultant image no longer includes outline 130.

Finally, the applications of some embodiments display, in stage 107, the outline suppressed, color corrected, spill suppressed greenscreen image against a background image. In stage 107, the background image is an image of a cave. As the composite image 170 shows, the man 110 does not have a bright outline that would look jarring against the dark background of the cave (shown in the negative as light gray).

Separately from the bright outline problem, there are some greenscreen images with undesired partially transparent pixels. These partially transparent pixels are the result of highlights or shadows on the green background of the source image. The highlights and shadows change the color of the background. In some embodiments, pixels that are very close to the main color of the background are rendered completely transparent while pixels that have colors close, but not very close, to the main color of the background are rendered partially transparent. The shadows and highlights of the original source image have colors that are close in color to the predominant color, but not very close in color.

Rendering pixels that are close in color to the main background color partially transparent is intended to allow clear objects (such as glass) in the source image to be rendered as partially transparent instead of completely transparent. However, the highlights and shadows on the green background in the source image sometimes change the color enough to put them outside the set of colors that are rendered entirely transparent. Thus, the shadows and highlights are partially visible on a composite image and partially block objects in the background image. To address this issue, some embodiments provide a tool to designate the colors in the shadows and highlights as completely transparent rather than partially transparent.

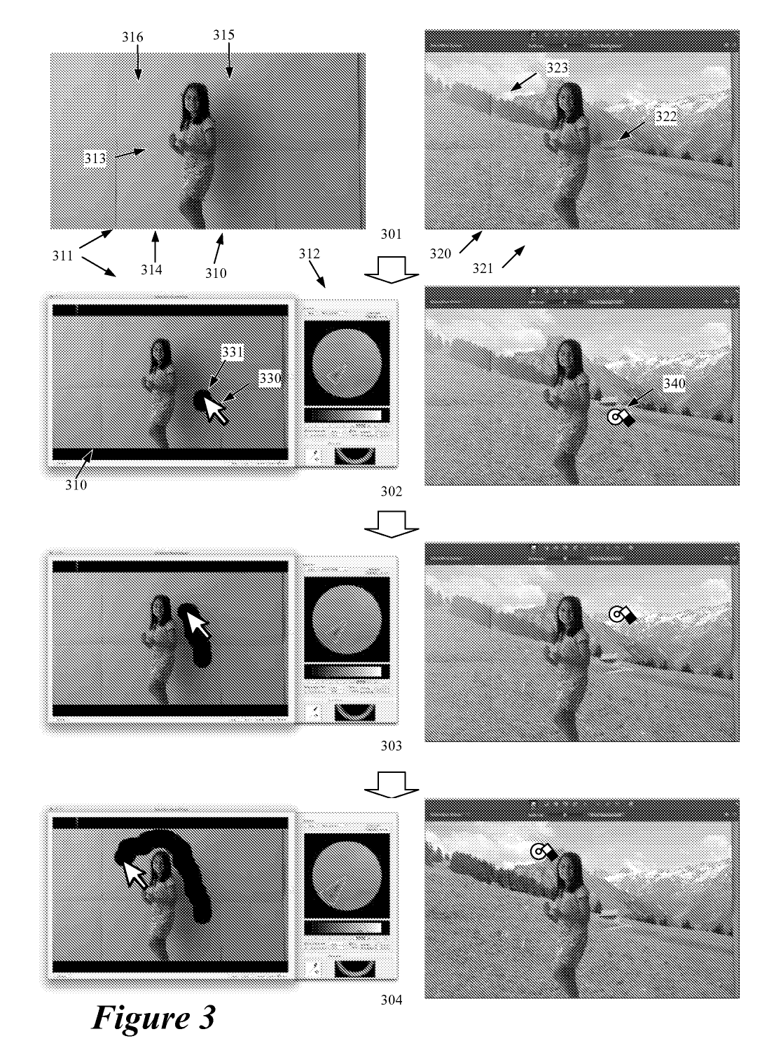

FIG. 3 illustrates a technique for removing undesired pixel colors from a greenscreen image. The figure is illustrated in four stages 301-304. Each stage includes two graphical user interfaces 311 and 321 of an image editing application of some embodiments that includes a color removal tool. The user interface 311 on the left side in each stage 301-304 shows a source image 310 from which a greenscreen image (i.e., an image with formerly green pixels designated as transparent) is derived. The source image 310 is shown in a source image interface 311. In stages 302-304, the interface 311 on the left side also includes a color selection scope 312 that displays what colors of the source image 310 have been selected to be transparent and what colors have been selected to be partially transparent. The right side of each stage 301-304 shows a composite image 320 in a composite image interface 321. The composite image interface 321 is for erasing (i.e., rendering transparent) parts of a greenscreen image while the greenscreen image is overlaid on a background image to form the composite image 320.

The two interfaces 311 and 321 represent alternative interfaces in which the same actions are performed by the user in each stage 301-304. Some embodiments provide both interfaces 311 and 321 as options. Some embodiments provide one interface or the other. The interfaces 311 and 321 are shown in the same figure (side by side) because neither interface 311 nor 321 alone displays both what is being done to the greenscreen image and what the effects of those actions on the composite image 320 are. It is difficult to see what parts of the source image are being selected in the composite image interface 321 and the effects on the composite image 320 of that selection are not shown in the source image interface 311. However, some embodiments provide interfaces that simultaneously show the greenscreen image against a background and show a copy of the source image.

In each stage 301-304, the same action is performed on each interface. In stage 301, the left side shows a full-screen mode of the source image interface 311 of some embodiments. In this example, the source image 310 is an image of a child 313 in front of a green wall 314. The child 313 casts a shadow 315 on the wall 314 to the right (viewer's right) of the child 313. The wall 314 also has a brighter area 316 to the left (viewer's left) of the child 313.

The effects of the shadow 315 and the brighter area 316 on the composite image 320 are also shown in stage 301 in composite image interface 321. The composite image 320 is a composite of a greenscreen image overlaid on a background image. The pixels in the source image 310 that were the predominant colors of the green wall 314 have been rendered transparent. However, the pixels in the source image 310 that are close to the predominant colors (e.g., shadows on the wall 314) have been rendered only partially transparent in the greenscreen image. As a result of the partial transparency of the colors close to the predominant colors of the green wall 314, the barn 322 in the composite image 320 in stage 301 is partially obscured by the effect of shadow 315 (the pixels of which are only partially transparent). The composite image 320 also includes trees 323 that are obscured by the effect of the partially transparent version of bright area 316 of wall 314.

In stage 301 the application has already selected a set of pixel colors (here, various shades of green), found within the source image 310, to render transparent and partially transparent in the greenscreen image. This set of pixel colors is sometimes called a “key”. A subset of the key colors are designated as fully transparent in the greenscreen image.

In stage 302, the application receives a command to add the colors of the shadow 315 to the fully transparent subset of the key colors. In stage 302, in the source image interface 311, a user clicks and drags a cursor 330 over part of the shadow 315 in order to select the colors of the shadow to be rendered as transparent in the greenscreen image. In the illustrated version of the source image interface 311, the set of selected pixels is represented by an irregular black area 331. The black area 331 includes all pixels within a given radius of the points along the track/path that the cursor leaves in the click-and-drag operation. In simpler terms, the black area is the area left by placing a black circle around the cursor's click location and dragging the black circle over the source image 310, leaving a trail of circles at all previous locations of the cursor during the click-and-drag operation. In some embodiments, the application does not display the entire black area 331, but instead shows only the cursor, shows a circle that moves with the cursor, but does not leave a trail, or replaces the cursor with a circle that does not leave a trail.

In the composite image interface 321, the user drags a cursor 340 that has been visually altered to resemble an eraser and a circle. The circle of cursor 340 indicates a selection radius of the click-and-drag motion in the composite image interface 321. In response to the click-and-drag operation (in either interface 311 or 321), the application identifies the colors of the selected pixels. The application then adjusts the greenscreen image by rendering as transparent all pixels in the greenscreen image that correspond to pixels in the source image 310 with the identified colors. The new transparency of pixels that were in the shadow 315 can be seen in stage 302. In stage 302, the barn 322, which had been obscured by the partially transparent pixels of shadow 315, is now fully visible.

In stage 303, the user continues to drag a cursor 330 or 340 (in their respective interfaces) further up the area occupied by shadow 315. However, the cursors select pixels that are very similar in color to the pixels previously selected (in stage 302). Accordingly there is little visible change in the composite image 320. In particular, in stage 303, the trees 323 are obscured because they are in an area of source image 310 that is a brighter green than the colors already designated as transparent and the cursors 330 and 340 have not reached that area yet in stage 303.

In stage 304, the user has dragged the cursor 330 or the cursor 340 into the brighter area 316. The application then renders transparent the pixels in the greenscreen image that correspond to pixels with that shade of green in the source image 310. As a result, the trees 323 can be seen clearly in composite image 320 in stage 304.

In section I above, two examples of solutions to bright outline and undesired partially transparent pixels were described. In the following sections, more details about greenscreen outline suppression and color removal tool will be discussed. More specifically, in section I, the outline suppression tool is described in more detail. Next, in section II, the color removal tool is described in more detail. In section III, a mobile device on which an application of some embodiments runs is described. Finally, in section IV, a computer on which an application of some embodiments runs is described.

### I. Greenscreen Outline Suppression

As mentioned above, in general as used herein the term “greenscreen” indicates that the embodiment encompasses both greenscreen and bluescreen. However, in the greenscreen outline suppression process of some embodiments, an image editing application distinguishes between greenscreen and bluescreen. In some embodiments, the bright outline around a dark-edged object is not present or is less prominent in a bluescreen image than it would be in a similar greenscreen image. Accordingly, some embodiments perform an edge brightness suppression technique on greenscreen images only and not on bluescreen images.

A. Outline Suppression Process

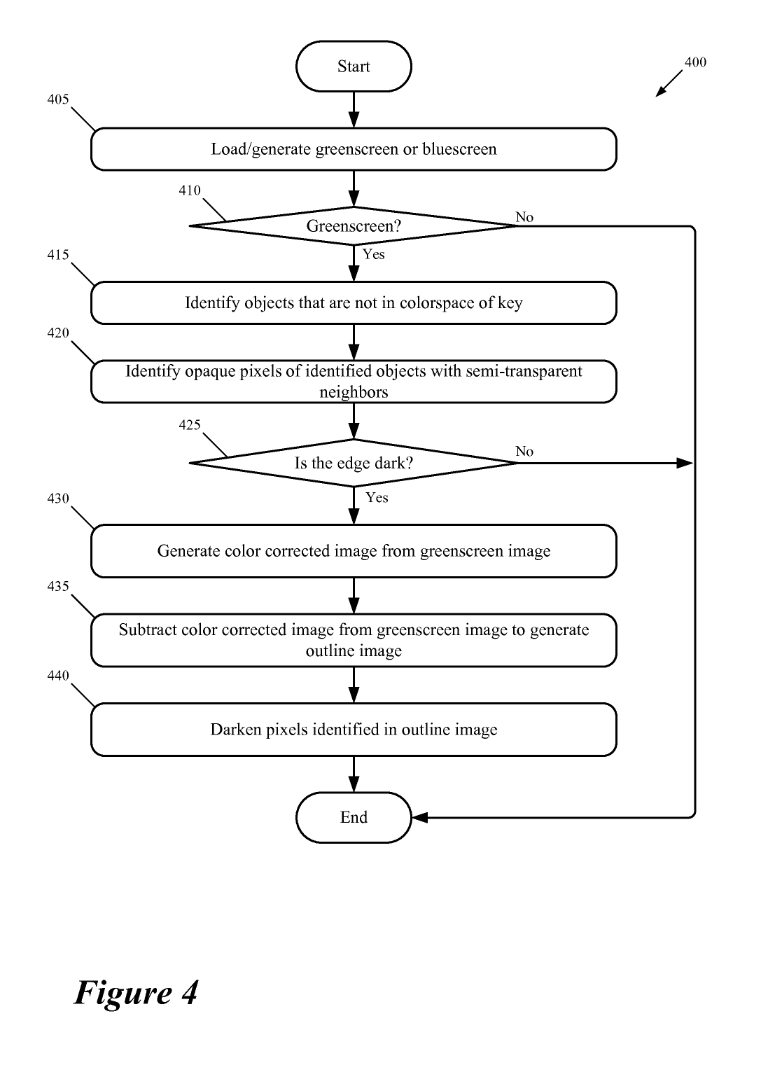

FIG. 4 conceptually illustrates a process 400 of some embodiments for suppressing a bright outline around a dark-edged object in a greenscreen image. The process 400 loads or generates (at 405) a greenscreen or bluescreen image. In some cases, the process begins with an already generated greenscreen or bluescreen image (e.g., image data with certain key colors of pixels designated as transparent or partially transparent). In some cases, the application starts with a source image with a blue or green background and generates a greenscreen/bluescreen image from the source image in operation 405. As previously mentioned, the set of color values that are completely or partially transparent are referred to herein as a “key”.

The process 400 then determines (at 410) whether the image has a blue or green background (e.g., by determining the predominant color of the background of a source image or identifying the color component values of the pixels designated as transparent in an already generated greenscreen/bluescreen image). When the image is a bluescreen image (or the background is blue), the process 400 ends. When the image is a greenscreen image (or the background is green), the process 400 proceeds to identify (at 415) objects that are not in the colorspace of the key (e.g., objects that are opaque or will be opaque when the greenscreen is generated). The process 400 then identifies (at 420) the pixels in the objects that are adjacent to pixels with color values in the key (e.g., transparent or partially transparent pixels in a greenscreen image or pixels that are the key colors in a source image). These opaque pixels next to transparent or partially transparent pixels (or next to green pixels in a source image) are identified as edge pixels.

After identifying the edge pixels the process 400 then determines (at 425) whether the edges are dark. In some embodiments, the determination that the edges are dark is based on a threshold fraction of the edge pixels (e.g., 50%) being darker than a threshold luminance (e.g., 20% of maximum possible luminance). Other embodiments use other criteria for identifying the edges as dark (e.g., whether the average brightness of the pixels is less than a threshold level, etc.). When the edges are not dark, the process 400 ends.

The process 400 then generates (at 430) a color corrected image from the greenscreen image. The process 400 generates the color corrected image by digitally removing the green tint from the greenscreen image to generate a color corrected, spill suppressed greenscreen image (sometimes referred to herein as a “color corrected image”). The color corrected image will still have a bright outline that is dimmer than the green outline in the greenscreen image.

The process 400 then subtracts (at 435) the color corrected image from the greenscreen image. In some other embodiments, the process subtracts the greenscreen image from the color corrected image. In general, the difference between the dark pixels of the color corrected image and the corresponding dark pixels of the greenscreen image will be small, while the difference between the bright outline of the color corrected image and the bright outline of the greenscreen image will be large. Accordingly, the result of the subtraction will be an image with a bright outline around an almost completely black object (called an “outline image”, herein).

Then the process 400 darkens (at 440) the pixels in the color corrected image according to how bright the corresponding pixels in the outline image are. Thus, the bright outline is darkened without over darkening the rest of the pixels in the color corrected image. The process 400 then ends.

Generating a greenscreen image that does not include a bright outline allows the application of some embodiments to produce composite images that lack a bright outline around the dark-edged greenscreen image. Such composite images are more realistic looking and less obviously computer generated than composite images that do have a bright outline between the dark edged objects and the background.

B. Identifying a Dark Edge

The application of some embodiments is capable of displaying an alpha values image. An alpha values image visibly displays the alpha values (opacity levels) of the pixels in a greenscreen image rather than displaying the colors of the pixels in the image. The application of some embodiments produces a grayscale alpha values image in which higher opacities are represented by darker colors. Both an application of some embodiments that can visually display an alpha values image and an application of some embodiments that cannot visually display an alpha values image use alpha values (or other measures of transparency or opacity) to determine where the edges of objects in a greenscreen image are. After determining where the edges are based on the alpha values of the pixels, some embodiments determine whether the edges are dark because bright outlines are most prominent next to dark edges.

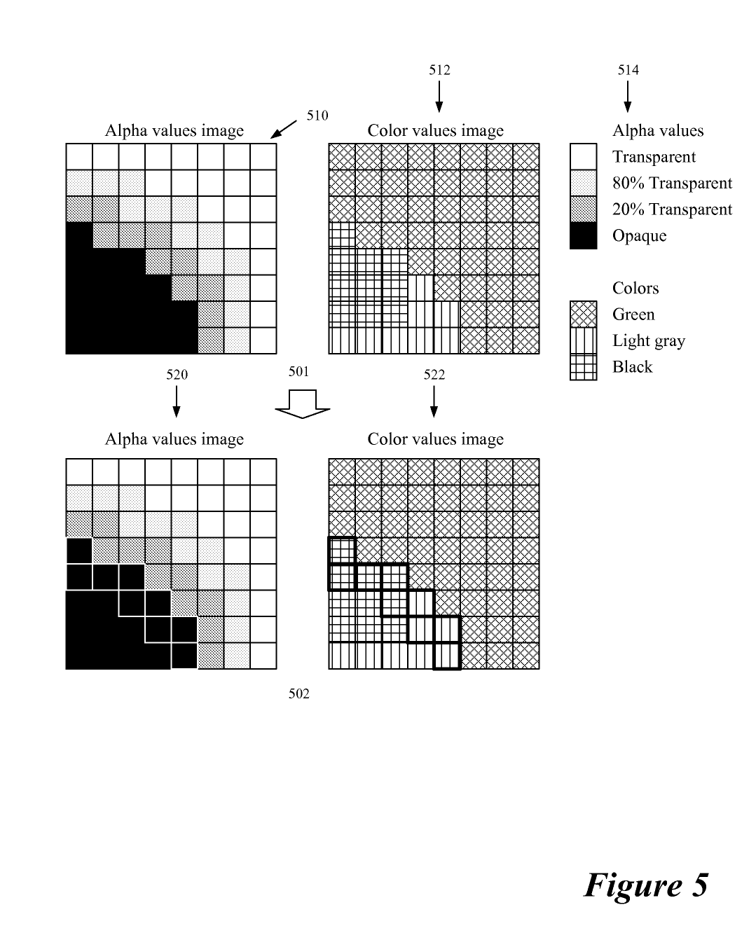

FIG. 5 conceptually illustrates how the edges are determined to be dark in some embodiments. The figure is shown in two stages 501 and 502. In stage 501, the pixels of a greenscreen image are represented in an alpha values image 510 as being black, dark gray, light gray or white depending on whether the pixels are opaque, 20% transparent, 80% transparent or completely transparent, respectively. The colors in an alpha values image (black, shades of gray, or white) do not represent the color component values of the pixels, but only the opacity of the pixels. In alpha values images of some embodiments, brighter pixels represent pixels that are more opaque while darker pixels represent pixels that are more transparent. In the illustrated example, there are only four levels of opacity in the legend 514 for a greenscreen image: transparent (shown as white), 80% transparent (shown as light gray), 20% transparent (shown as dark gray) and opaque (shown as black). However, one of ordinary skill in the art will understand that in some embodiments pixels with many different levels of transparency can be part of a greenscreen image.

As mentioned above, the alpha values of the pixels do not represent the color component values of the pixels. Each pixel in a greenscreen image of some embodiments has three color component values (e.g., R, G, and B, or Y, C_{b}, and Cᵣ) and a separate alpha value. In stage 501, the same set of pixels as shown in the alpha values image 510 is also displayed in a color values image 512. Because color values are not the same as alpha values, the pixels look different in the different representations.

In color values image 512, the colors green, light gray, and black are represented by a diagonal crosshatch pattern, a vertical lines pattern, and a horizontal/vertical crosshatch pattern, respectively as also seen in legend 514 of the greenscreen image. However, one of ordinary skill in the art will understand that in some embodiments other colors can be part of a greenscreen image. The color component values of the pixels as displayed in color values image are not dictated by the opacity of the pixels. An opaque pixel could be any color except a color that is designated as always being partially or fully transparent. For example, in alpha values image 510, there are eighteen black pixels (pixels designated as fully opaque). However, the colors of those eighteen pixels can only be determined (in the figure) by looking at the corresponding pixels in color image 512. Eight of the eighteen pixels are identified as light gray (with horizontal stripes as identified in legend 514) and ten of the eighteen pixels are identified as black (with horizontal and vertical lines as identified in legend 514). However, all of those pixels are identified in alpha values image 510 as opaque (black as identified in legend 514).

In stage 502, the edge pixels have been identified. In alpha values image 520, the edge pixels are shown as black with white outlines. In color values image 522, the edge pixels are shown with thicker outlines. The edge pixels, as shown in color values image 522 include 5 black pixels and 4 light gray pixels. In some embodiments an edge is dark when half of the pixels are darker than a threshold brightness. In some other embodiments an edge is dark when ⅔ of the pixels are darker than a threshold brightness, etc. In yet some other embodiments an edge is dark when the average brightness of the edge pixels is below a threshold brightness. Accordingly, the determination of whether the edge identified in this figure is dark would depend on the embodiment.

In some embodiments, the edge determinations are used to identify the outlines to be suppressed. However in some embodiments, the application uses the dark edge determination to determine whether to suppress an outline, but the dark edge determination is not used to identify the outline to be suppressed. Operations of some such embodiments are further described below.

C. Outline Suppression Operations

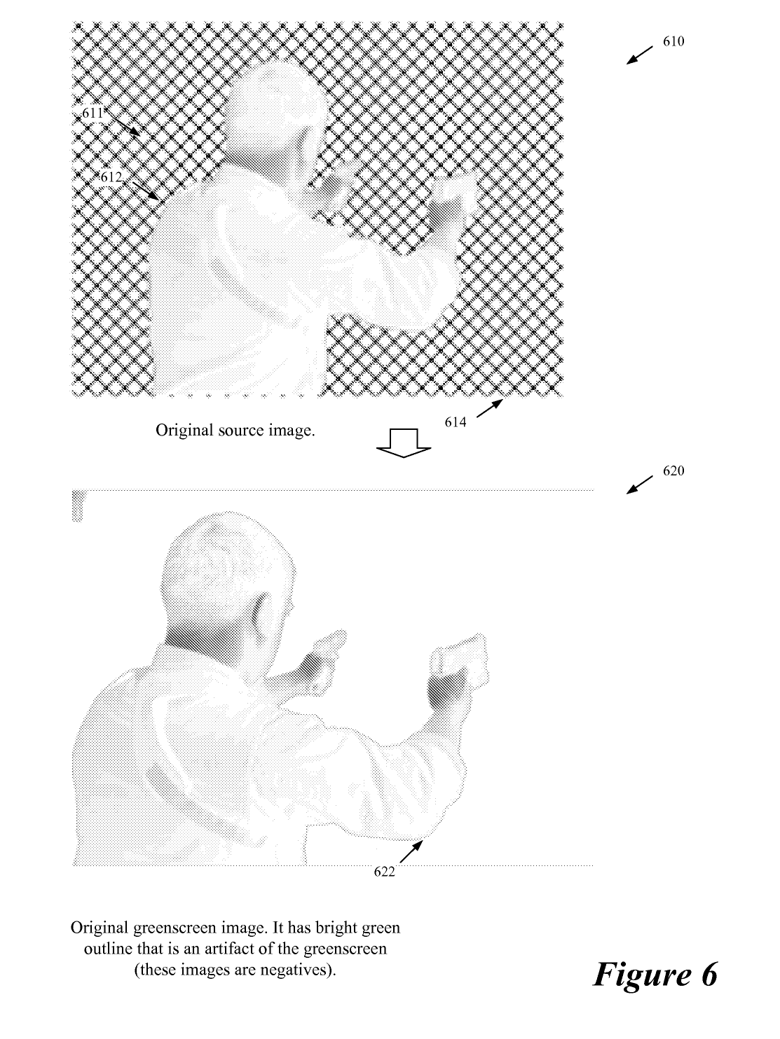

FIG. 6 illustrates an example of a transition from a source image to a greenscreen image and visually demonstrates how obvious a bright outline is against a dark edge. The images are both shown as negatives. The figure includes source image 610 and a composite image 620 of a greenscreen image (generated from source image 610) against a black background. The source image 610 includes a man 611 in a dark shirt 612 and a green background 614. The green background 614 is illustrated with diagonal crosshatching. The green background 614 is rendered transparent in the greenscreen image. Composite image 620 is a composite of the greenscreen image generated from source image 610 against a black background image. The transparent pixels allow the black background image (shown as white because the source image 610 is a negative) to show through the greenscreen image in the composite image 620. In the composite image 620, the man 611 is still shown, almost identically to the corresponding part of source image 610. However, the man 611 in the composite image 620 has a bright (green) outline 622 (shown as dark because the composite image 620 is a negative). The bright green outline is obvious against the black background image used for composite image 620.

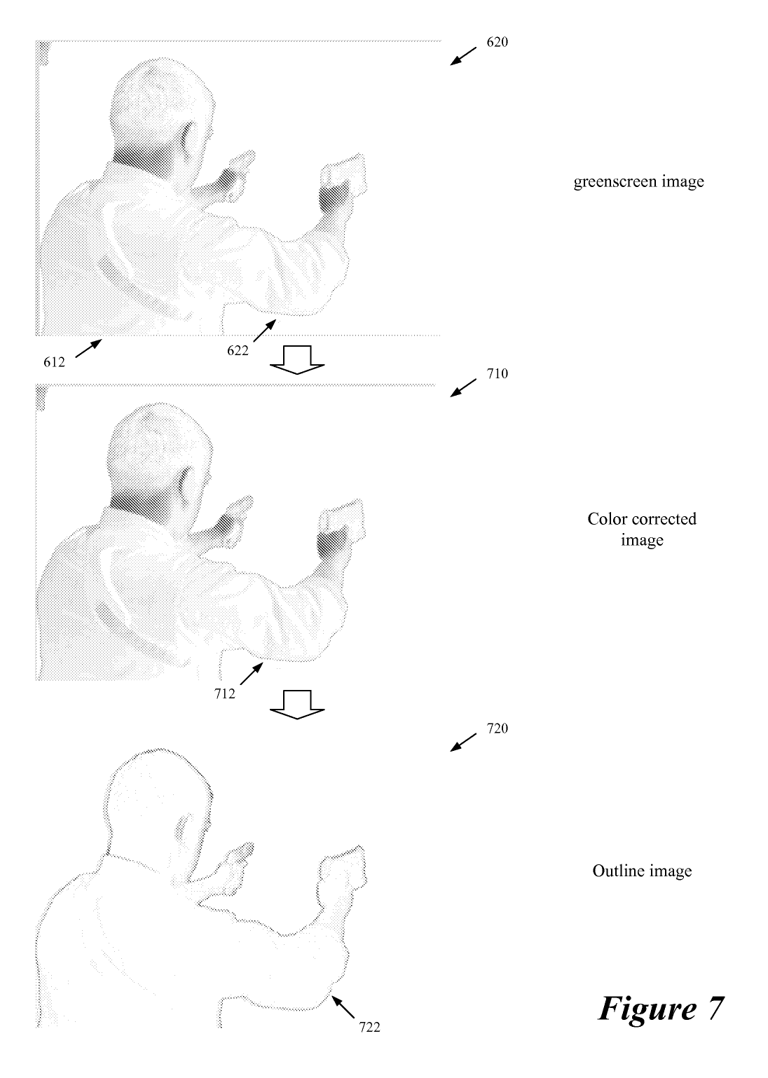

FIG. 7 illustrates the generation of an outline image. Again, the images in the figure are all negatives. The figure includes 3 images: composite image 620 (of a greenscreen image on a black background), composite image 710 (of a color corrected, spill suppressed greenscreen image against a black background) and outline image 720. The images are generated sequentially in some embodiments. The application generates the greenscreen image of composite image 620 from a source image (as described with respect to FIG. 6). The application generates the color corrected, spill suppressed greenscreen image of composite image 710 from the greenscreen image by performing a color correction operation that removes the green spill of the entire green screen, which removes virtually all green from the image.

Some embodiments color correct the greenscreen image to generate the color corrected, spill suppressed greenscreen image. In some embodiments, the image editing application shifts the average color of the image toward neutral (colors cancel out on average). The shirt 612 was already dark and therefore does not change a great deal when the greenscreen image of composite image 620 is replaced with a color corrected, spill suppressed greenscreen image in composite image 710. However, the color correction process reduces the luminance of the outline 622 from a bright green outline 622 to a dimmer gray outline 712.

The image editing application then subtracts the green spill removed greenscreen image from the greenscreen image to generate the outline image 720. Apart from the outlines 622 and 712, corresponding pixels in the images are almost the same and so almost entirely cancel each other out. However, the outline 712, being dimmer than outline 622 does not cancel it out. Accordingly, outline image 720 includes only the outline 722.

After generating an outline image, the application of some embodiments uses the outline image to modify the color corrected image to suppress the bright outline. A demonstration of the results of such a modification is provided in the next figure.

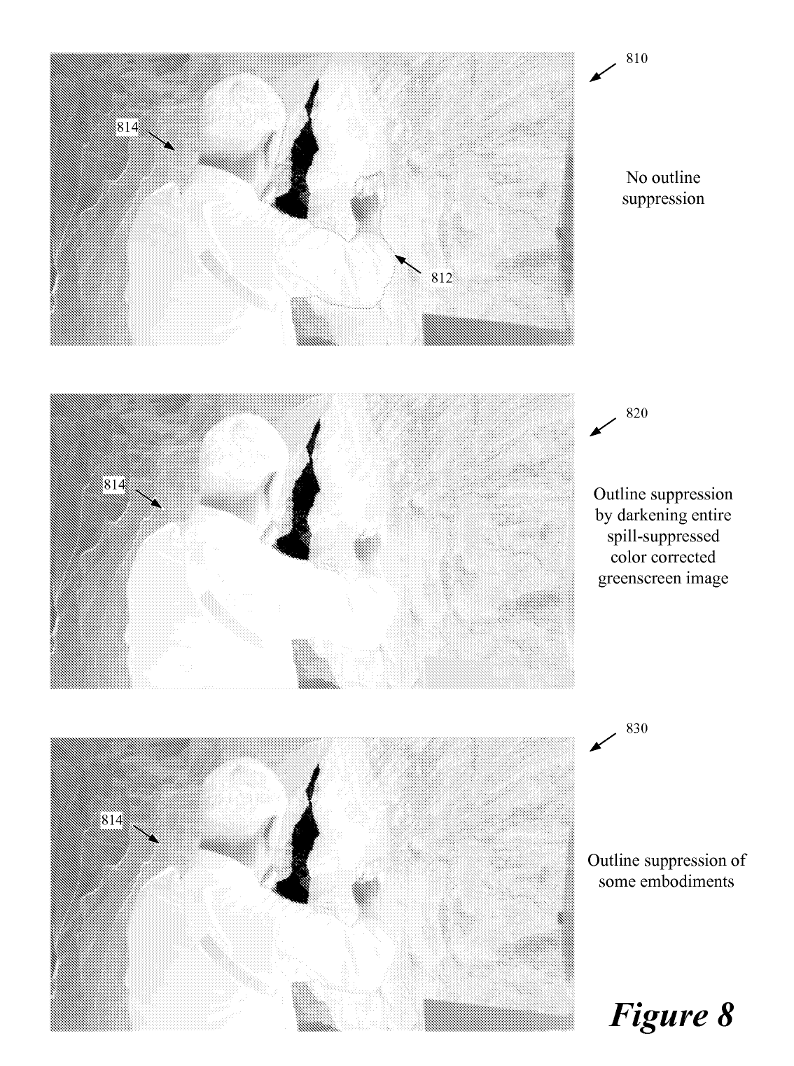

FIG. 8 illustrates examples of composite images that are generated with various techniques. FIG. 8 includes a composite image 810, a composite image 820, and a composite image 830. Composite image 810 is a composite of a cave background image and a greenscreen image with no outline suppression. Composite image 820 is a composite of the cave background image and a greenscreen image that is generated by darkening all pixels of a color corrected, spill suppressed image. Composite image 830 is a composite of the cave background image and a greenscreen image generated by subtracting an outline image from a color corrected, spill suppressed image. The composite images 810, 820, and 830 are all shown here as negatives.

Composite image 810 is an image generated by imposing a color corrected, spill suppressed greenscreen image on the background image of a cave. The bright outline 812 around the man 814 is still present. The outline 812 is most obvious in areas of the image in which the outline 812 is next to a dark area of the background, such as near the right arm of the man 814.

In composite image 820, the greenscreen image of composite image 820 was generated by taking a color corrected, spill suppressed image and darkening the entire image. The darkening of the image is done to reduce the luma of the brighter gray areas that were left behind when the color corrected spill suppressed image was generated. This method does suppress the outline, which is not present in composite image 820. However, this method has the incidental effect of darkening the entire image, including parts that were already dark. This can be seen in the negative composite image 820 as a lightening of the entire man 814 as compared to composite image 810. For example, in composite image 820, there is less detail due to the darkening (lightening in the negative image) of the hair and left shoulder of the man 814 than in composite image 810. As it is sometimes undesirable to darken the entire object, this method is not always used. Instead, a method which predominantly darkens the outline is used to produce composite image 830.

Composite image 830 provides the best characteristics of the other two composite images. The outline 812 has been suppressed by reducing the brightness of the pixels of the color corrected, spill suppressed greenscreen image in only those areas corresponding to bright pixels in an outline image. The outline in the outline image is bright; therefore the outline 812 has been greatly darkened and is not visible. The rest of the man 814, in the outline image, was black (or almost black), so the rest of the man 814 was not darkened (or not darkened much). Accordingly, the detail on the hair and left shoulder of the man 814 is uncompromised by darkening (lightening in the negative) in composite image 830.

### II. Color Removal Tool

Separately from the bright outline problem, there are some greenscreen images with undesired partially transparent pixels. These partially transparent pixels are the result of highlights or shadows on the green background of the source image. The highlights and shadows change the color of the background. In some embodiments, pixels that are very close to the main color of the background are rendered completely transparent while pixels that have colors close, but not very close, to the main color of the background are rendered partially transparent. The shadows and highlights of the original source image have colors that are close in color to the predominant color, but not very close in color.

Rendering pixels that are close in color to the main background color partially transparent is intended to allow clear objects (such as glass) in the source image to be rendered as partially transparent instead of completely transparent. However, the highlights and shadows on the green background in the source image sometimes change the color enough to put them outside the set of colors that are rendered entirely transparent. Thus, the shadows and highlights are partially visible on a composite image and partially block pixels in the background image. To fix this issue, some embodiments provide a tool to designate the colors in the shadows and highlights as completely transparent rather than partially transparent.

In some embodiments, instead of or independently of the outline suppression tool, the application provides a tool for removing undesired pixel colors from a greenscreen image. The tool of some embodiments allows a user to rapidly select an irregular area of the image. The tool then adds the colors of the pixels in the selected area to the key that determines which colors will be rendered transparent in the greenscreen image. The tool of some embodiments also works with bluescreen images.

A. Process for Removing Undesired Pixel Colors From a Greenscreen Image

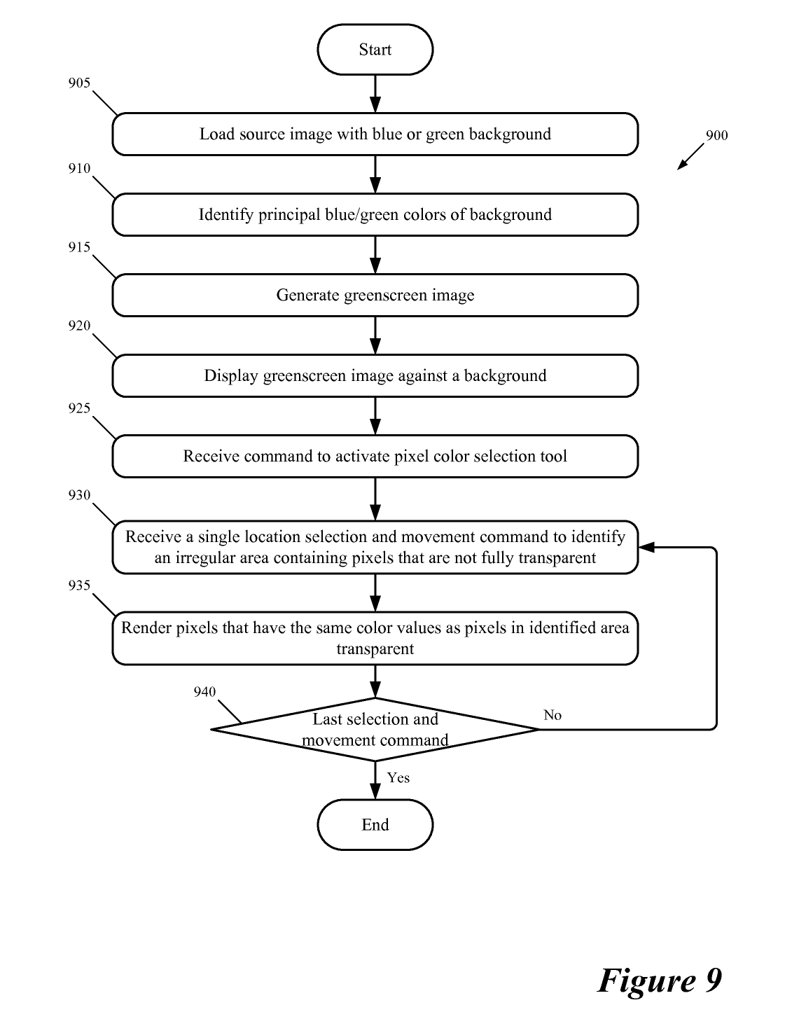

FIG. 9 conceptually illustrates a process 900 of some embodiments for removing undesired pixels in a greenscreen image. The process 900 loads (at 905) a source image with a blue or green background. The process 900 then identifies (at 910) the principal blue or green colors of the background. The process 900 then generates (at 915) a greenscreen image, rendering all pixels with the predominant colors transparent in the greenscreen image. In some embodiments, the process 900 displays (at 920) the greenscreen image against a background.

In some embodiments, some or all of the above operations 905-920 may be performed at different times than the others. For example, in some embodiments the application can prepare a greenscreen image ahead of time and then load the greenscreen image rather than loading the source image and generating a greenscreen image from the source image.

The process 900 then receives (at 925) a command to activate a pixel color selection tool. In some embodiments, the application provides a button to switch to a mode in which the color selection tool is active. In other embodiments the color selection tool may be activated by the selection of a keyboard key, a sustained pressing of a keyboard key while a cursor control selects an area of the image, etc.

The process 900 then receives (at 930) a single command that selects a location and moves that selection along a specific path to another location. The command identifies an irregularly shaped area of the greenscreen image containing at least one pixel that is not fully transparent (i.e., partially opaque and opaque pixels). In some embodiments, the command is a left-click, drag, and release command from a cursor control. In some embodiments, the command is a touch-and-drag command on a touch sensitive screen, etc. In some embodiments, the irregular area defined by the single command includes all pixels within a specified distance of the path of the command (e.g., a circular area around a cursor as the cursor is dragged along a user specified path). In other embodiments, the irregular area defined by the single command represents an area formed by dragging a rectangle or other regular shapes along a user specified path.

After receiving the selection of the irregular area, the process 900 identifies the pixels in the greenscreen image that have the same color as pixels in the identified area and renders (at 935) those pixels transparent. For example, the process 900 of some embodiments adds the colors of the selected pixels to the key that identifies colors of pixels to render as transparent in the greenscreen image.

In some embodiments, multiple irregular areas can be designated, each with a single location selection and movement command. Accordingly, the process 900 determines (at 940) whether the last location-selection-and-motion command has been received (e.g., whether the control that activates the tool has been deactivated). When the last command has not been received, the process 900 returns to operation 930. When the last command has been received (e.g., when a button that toggles the color selection tool on and off has been deactivated) the process 900 ends.

B. User Interface for Removing Unwanted Pixels From a Greenscreen Image

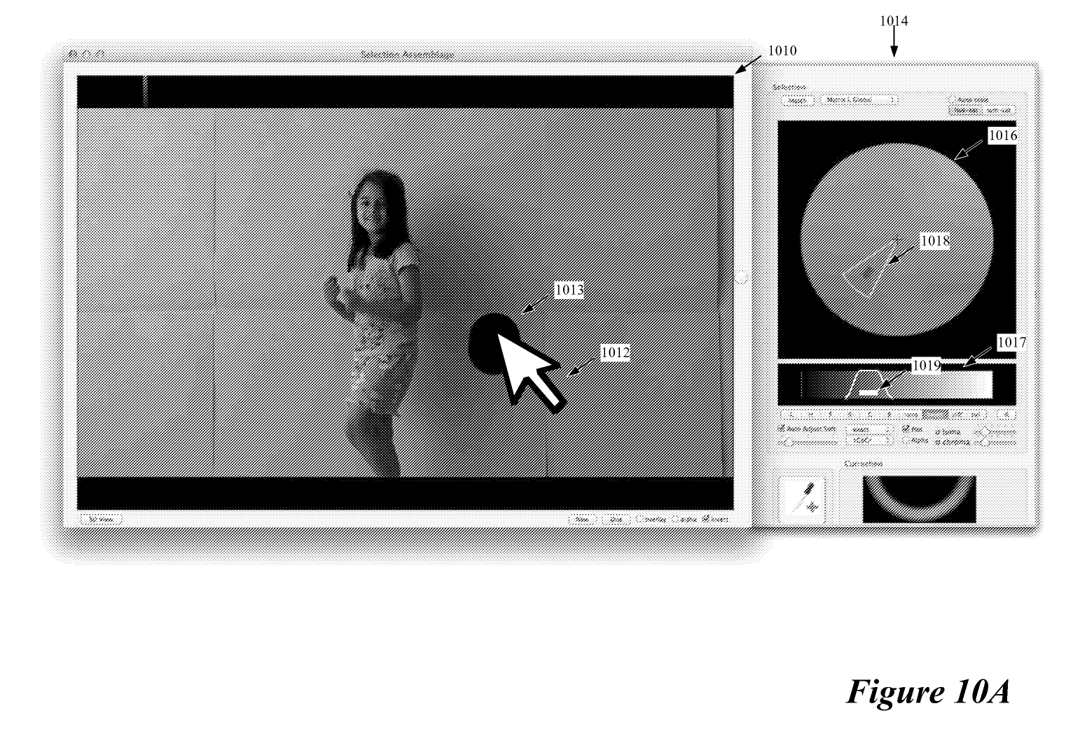

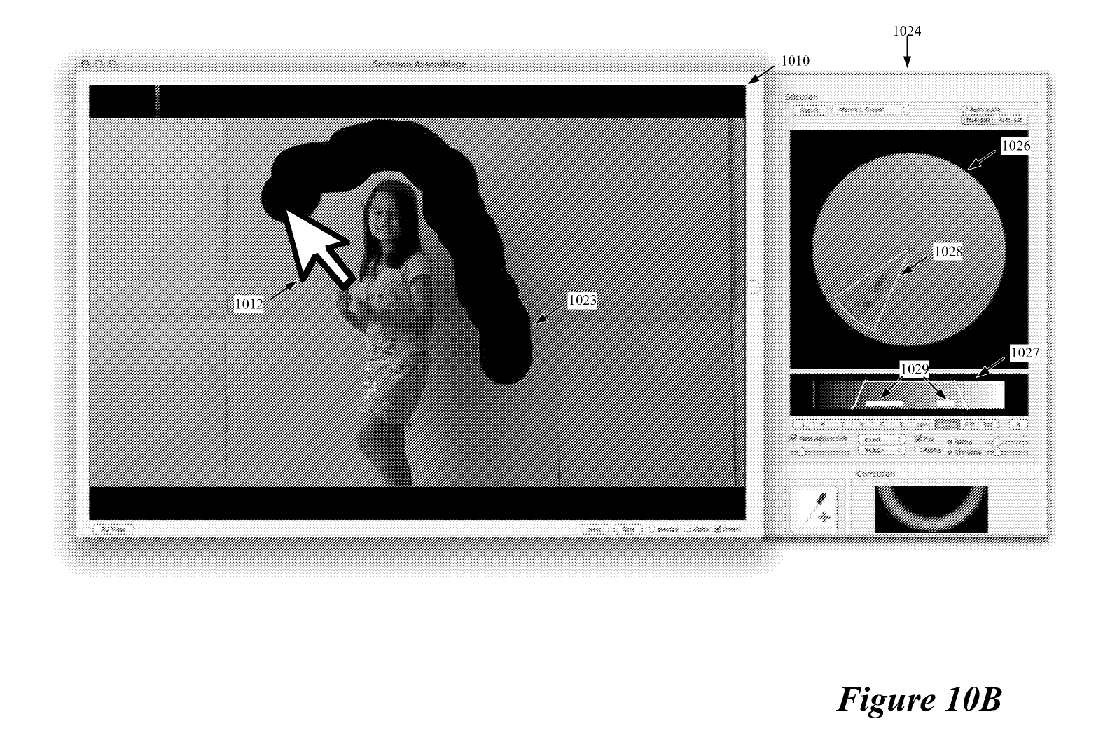

FIGS. 10A illustrates a user interface receiving the beginning of a selection of an irregular area in some embodiments. FIG. 10B illustrates the user interface receiving the end of the selection of an irregular area. FIG. 10A includes image 1010, cursor 1012, selected irregular area 1013 and color selection scope 1014. Image 1010 is a source image with a child against a green background. On image 1010, cursor 1012 has begun selecting an irregular area 1013. Color selection scope 1014 displays color wheel 1016 and luminance graph 1017. Color wheel 1016 visually represents the set of all possible combinations of hue and saturation values. The hue values are indicated by the angle of a position on the color wheel 1016. The saturation values are indicated by the distance of a position on the color wheel 1016 from the center of color wheel 1016. The luminance graph 1017 represents the set of possible luminance values of pixels. In addition to representing all possible hue/saturation combinations, color wheel 1016 contains key area 1018. The key area 1018 contains three features: (1) the selected saturation/hue combinations of the selected irregular area 1013 (represented by the dark, indicator pixels in the center of key 1018), (2) the transparency box surrounding the identified saturation/hue values and (3) the partial transparency box forming the outline of the key 1018.

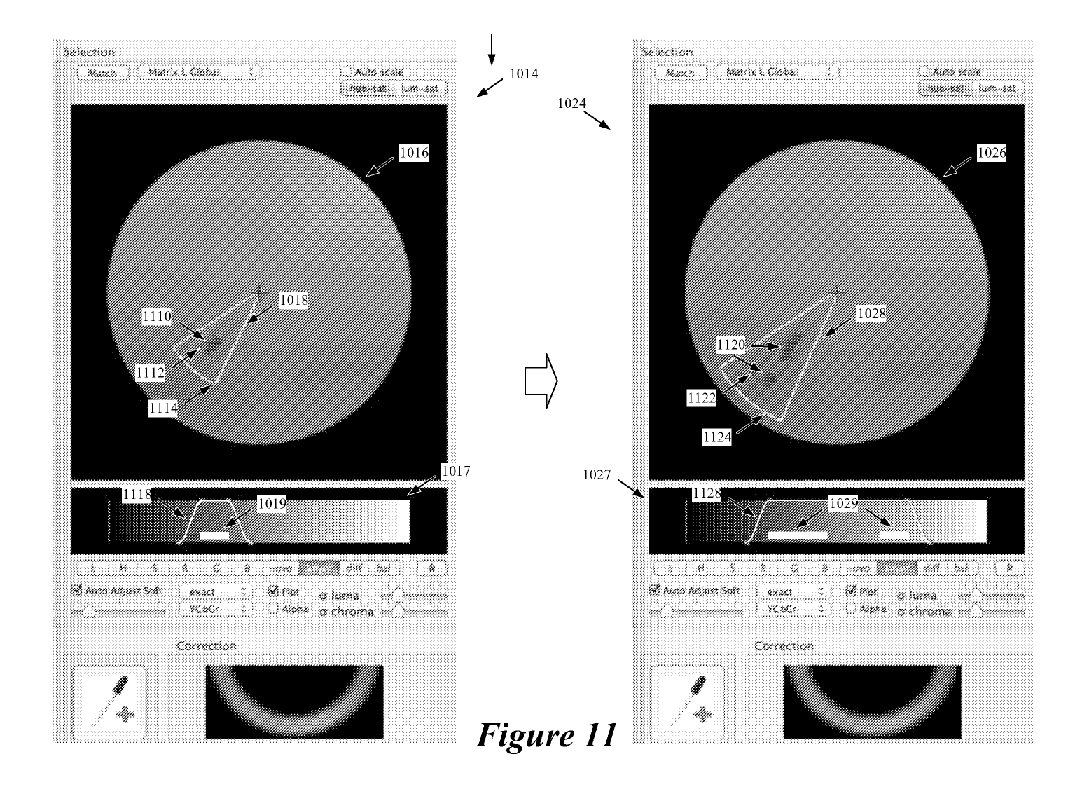

The luminance graph 1017 displays indicator bar 1019 that indicates the luminance values of pixels that will be rendered fully transparent in a greenscreen image generated from image 1010. Color wheel 1016 and luminance graph 1017 are described further with respect to FIG. 11, below.

The application of some embodiments displays the saturation and hue values of the pixels in the selected area 1013 as dark pixels, in the center of key area 1018, on the color wheel 1016. Some embodiments use brown pixels, though other embodiments display the selection identifying pixels in other colors. To distinguish the dark pixels (representing the selected saturation and hue values) on the color wheel 1016 from the previously described dark pixels of images, the pixels on the selection scope will be referred to, with respect to FIGS. 10 and 11, as “indicator pixels”.

The indicator pixels are contained by a bounding box that identifies the set of hue and saturation values of the pixels in selected irregular area 1013. The application of some embodiments will render pixels in image 1010 with certain combinations of hue, saturation, and luminance values as completely transparent. In some embodiments, only pixels with hue and saturation values within the bounding box of key area 1018 and luminance values indicated by indicator graph 1019 of luminance graph 1017 will be rendered completely transparent. The determination of which pixels will be rendered completely transparent and which pixels will be rendered partially transparent will be described further with respect to FIG. 11. The bounding box is surrounded by a wedge shaped outline around the key area 1018. Pixels in the image 1010 with (1) hue and saturation values represented by positions inside the wedge shaped outline, but (2) outside the bounding box, and (3) with luminance values on or near indicator bar 1019, will be rendered as partially transparent in the greenscreen image.

In FIG. 10A, the set of selected pixel colors is small, and is taken from an area of the source image 1010 that contains pixels that are of middling saturation values and various green hue values. Accordingly, the indicator pixels on the color wheel 1016 are located approximately half way from the center of the color wheel 1016 (i.e., the location representing zero saturation) to the edge of the color wheel 1016 (i.e., the location representing maximum saturation), in the green section of the color wheel 1016. The selected pixels also have relatively low luminance values, accordingly, the indicator bar 1019 of the luminance graph 1017 indicates relatively dark luminance values.

FIG. 10B includes the same source image 1010 after the cursor 1012 has selected a larger irregular area 1020. FIG. 10B includes irregular area 1023, a colors scope 1024 with color wheel 1026 and luminance graph 1027. The color wheel 1026 displays key area 1028. In this figure, the irregular area 1023 encompasses some pixels that are more saturated and some pixels that are less saturated than the pixels selected by area 1013 in FIG. 10A. The pixels that are less saturated than the pixels selected by area 1013 are closer to the center of color wheel 1026 than the pixels selected by area 1013. The pixels that are more saturated than the pixels selected by area 1013 are farther from the center of color wheel 1026 than the pixels selected by area 1013. Similarly, the luminance values of the selected pixels in area 1023 include some values that are larger and some values that are smaller than the luminance values of the selected pixels in area 1013. Accordingly, the indicator bars 1029 extend to both lighter and darker areas of the luminance graph.

In some embodiments which provide a visible indicator of the selected area (e.g., a black area), the parts of the image covered by the visible indicator return to their original color when the selection and motion command is over (e.g., when the cursor button is released or the finger leaves the touchscreen). In other embodiments, the black area remains and all pixels designated as transparent turn black as well when the location-selection-and-motion command is released.

By receiving the selection of the pixels and rendering all pixels with the same colors as the selected pixels transparent, the application removes the unwanted pixels from the image. Without the unwanted pixels, the background image shows through clearly in the areas where it is supposed to show through clearly.

C. Display, Indicating Which Pixel Colors are Partially or Fully Transparent

In some embodiments, pixels are designated as transparent, partially transparent, or opaque based on their saturation, hue, and luminance values. In some embodiments, in order for the pixels to be rendered at least partially transparent, the pixels should have (1) hue and saturation values in a key area of a color wheel and (2) luminance values in the plot area of the corresponding luminance graph. In some embodiments, the application generates a potential transparency value between 0 and 1 for each hue value, each saturation value, and each luminance value. That is, there is a first potential transparency value based on the hue value of the pixel, a second potential transparency value based on the saturation value of the pixel, and a third potential transparency value based on the luminance value of the pixel. The application of some embodiments sets a final transparency value for a pixel as the mathematical product of the potential transparency values associated with the hue, saturation, and luminance of the pixel. Other embodiments use other mathematical methods to determine partial and full transparencies.

The application of some embodiments sets the potential transparency values for each hue, saturation, and luminance value based on the selected pixels in the image. For any set of selected pixels there is a maximum and a minimum hue value. Not all hue values in between the maximum and minimum hue values will necessarily be represented in the selected pixels. However, the application of some embodiments sets a potential transparency value of 1 for all hue values between the maximum and minimum hue values of the selected pixels. Similarly, the application of some embodiments sets a potential transparency value of 1 for saturation values between the maximum and minimum saturation value of the selected pixels. Likewise, in some embodiments, the application sets the potential transparency value to 1 for luminance values between the maximum and minimum luminance values of the selected pixels. In some embodiments, hue, saturation, and luminance values outside the range of the selected values are given potential transparency values between 0 and 1 that decrease the farther the hue, saturation, or luminance value is from the selected set of values. For example, is the luminance values of the selected pixels range from 0.4 to 0.6, then a luminance value of 0.45 would have a potential transparency value of 1; a luminance value of 0.35 would have a potential transparency value of 0.6; a luminance value of 0.3 would have a potential transparency value of 0.2, etc. While the preceding example used a linear decrease in potential transparency value, some embodiments use non-linear decreases in potential luminance values.

In some embodiments, the speed at which the potential transparency values fall off is a user determined feature. If the user sets the feature to fall off slowly, then a wider range of pixel color values will be partially transparent. If the user sets the feature to fall off quickly, then a narrower range of pixel color values will be transparent.

In some embodiments there are three possible outcomes for transparency: (1) if all the potential transparency values are 1, then the pixel will be fully transparent; (2) if any of the potential transparency values are 0, then the pixel will be fully opaque; (3) otherwise, the pixel will be partially transparent.

Although the embodiments described so far in subsection C. use the products of potential transparency values for hue, saturation, and luminance, other embodiments use other mathematical methods to determine partial and full transparencies. For example, some embodiments set a transparency value for each hue/saturation combination and a second potential transparency value for each luminance value and use the product of those potential transparency values to determine transparency of a pixel. Other embodiments use mathematical functions other than products to calculate an actual transparency value from potential transparency values of color components.

Some embodiments provide data displays (e.g., color selection scopes) that indicate which hue, saturation, and luminance values are potentially transparent. FIG. 11 illustrates a larger view of color selection scopes 1014 and 1024 from FIGS. 10A and 10B. The color scopes 1014 and 1024 include color wheels 1016 and 1026 and luminance graphs 1017 and 1027 of some embodiments. The color wheels 1016 and 1026 each illustrate colors around a central location and contain key areas 1018 and 1028, respectively. Key area 1018 includes indicator pixels 1110, bounding box 1112, and outline 1114. Key area 1028 includes indicator pixels 1120, bounding box 1122, and outline 1124. Luminance graph 1017 includes plot 1118 and indicator bar 1019. Luminance graph 1027 includes plot 1128 and indicator bars 1029.

In some embodiments, the color wheel is a hue/saturation color wheel. The angle of a location relative to the center of the color wheel determines the hue that the location represents (e.g., green at the lower left, blue at the lower right, red at the upper right, etc.). The distance from a location on the color wheel 1016 or 1026 to the center of the color wheel determines the saturation that the location represents. The greater the distance, the more saturated the color that the location represents. In some embodiments, the color wheels 1016 and 1026 show the particular colors of each location (e.g., the green area starts out a faded green in the center and gradually shifts to a saturated green toward the edge). In some embodiments, color wheels are defined by the YC_{b}Cᵣ values. In some embodiments, the color wheels display multiple values of C_{b} and Cᵣ, with a set value of Y (e.g., a Y value at the middle of the scale of Y values).

The color wheels 1016 and 1026 each display a key area 1018 and 1028 respectively. The key area 1018 contains indicator pixels 1110, surrounded by bounding box 1112, which is itself surrounded by outline 1114 of the key area 1018. The indicator pixels 1110 represent the hue/saturation values of the pixels in the selected area (i.e., area 1013 of FIG. 10A). In some embodiments, the bounding box 1112 is a wedge shaped box that encloses all colors found between the maximum angle of any selected pixel color and the minimum angle of any selected pixel color and found between the most saturated selected pixel color and the least saturated selected pixel color. Similarly, the key area 1028 contains indicator pixels 1120, surrounded by bounding box 1122, which is itself surrounded by outline 1124 of the key area 1028. The indicator pixels 1120 represent the hue and saturation values of the pixels in the selected area (i.e., area 1023 of FIG. 10A).

The differences between key areas 1018 and 1028 are caused by the different selection areas 1013 and 1023 in FIGS. 10A and 10B, respectively. More specifically, the differences in the key areas 1018 and 1028 are caused by the different hue/saturation values of the pixels in the selected areas 1013 and 1023. The indicator pixels 1110 cover a smaller area than the indicator pixels 1120, because the selection area 1013 (of FIG. 10A) contains a subset of the pixel hue/saturation values of selection area 1023 (of FIG. 10B). Similarly, the bounding box 1112 of the indicator pixels 1110 is a subset of the bounding box 1122 of the indicator pixels 1120. In some embodiments, the entire key area 1028 will be larger than the key area 1018.

In some embodiments, the bounding box (e.g., bounding box 1112 or 1122) represents the set of hue and saturation values that designate a pixel as potentially fully transparent (e.g., the set of hue and saturation values with a potential transparency value of 1). Pixels with these hue and saturation values will be fully transparent, partially transparent, or opaque, depending on their luminance values. Similarly, in some embodiments, the area between a bounding box and a key outline (e.g., key outline 1114 or 1124) represents the set of hue and saturation values that designate a pixel as potentially partially transparent (e.g., the set of hue and saturation values with potential transparency values between 1 and 0, not including 1 and 0). Pixels with these hue and saturation values will be partially transparent or opaque, depending on their luminance values. In some embodiments, pixels with hue and saturation values outside the key outline (e.g., outline 1114 or 1124) will be opaque, regardless of their luminance values (e.g., these hue and saturation values have a potential transparency value of 0).

In addition to the color wheels 1016 and 1026, the scopes 1014 and 1024 of some embodiments also provide luminance graphs 1017 and 1027. The luminance graph 1017 displays a plot 1118 of the luminance values of the image on the horizontal axis and a potential transparency value assigned to pixels of that saturation value on the vertical axis. The indicator bar 1019 on the graph 1017 represents the luminance values of the selected pixels (i.e., the pixels selected in area 1013 in FIG. 10A).

The plot 1118 shows that the potential transparency value of the selected pixels' luminance values is 100%. That is, the plot is at full scale over the indicator bar 1019. Pixels with luminance values near the luminance values of the selected pixels, but outside those luminance values are potentially partially transparent instead of fully transparent. The potential value of transparency (e.g., 20% transparent, 80% transparent, etc.) of those pixel luminance values decreases the farther their colors are from the bounding box 1122. This is indicated by the sides of plot 1118, which drop lower the farther they are from the selected values shown in indicator bar 1019. Accordingly, pixels with hue and saturation values in the bounding box 1112 and close to the luminance values of the selected colors will be almost transparent, while pixels with hue and saturation values that are within the bounding box 1112, but far from the luminance values of the selected colors will be opaque even if they are the same hue and saturation as the selected colors.

The luminance graph 1027 of some embodiments also displays a plot 1128 of the luminance values of the image on the horizontal axis and the transparency of the color on the vertical axis. The indicator bars 1029 on the graph 1027 represent the ranges of luminance values of the selected pixels. The curve 1128 on the graph represents the potential transparency value of the luminance value. The plot 1128 shows that the transparency of the selected pixels' luminance values and all luminance values between any selected pixels luminance values is 1. The transparency of the surrounding pixel luminance values drops off the farther from the end of the selected saturations they are. Accordingly, pixels with hue and saturation values in the bounding box 1122 and luminance values near the maximum and minimum luminance values of the selected pixels will be almost transparent, while colors that are far from the luminance values of the selected colors will be opaque even if they are the same hue and saturation as the selected colors.

### III. Mobile Device

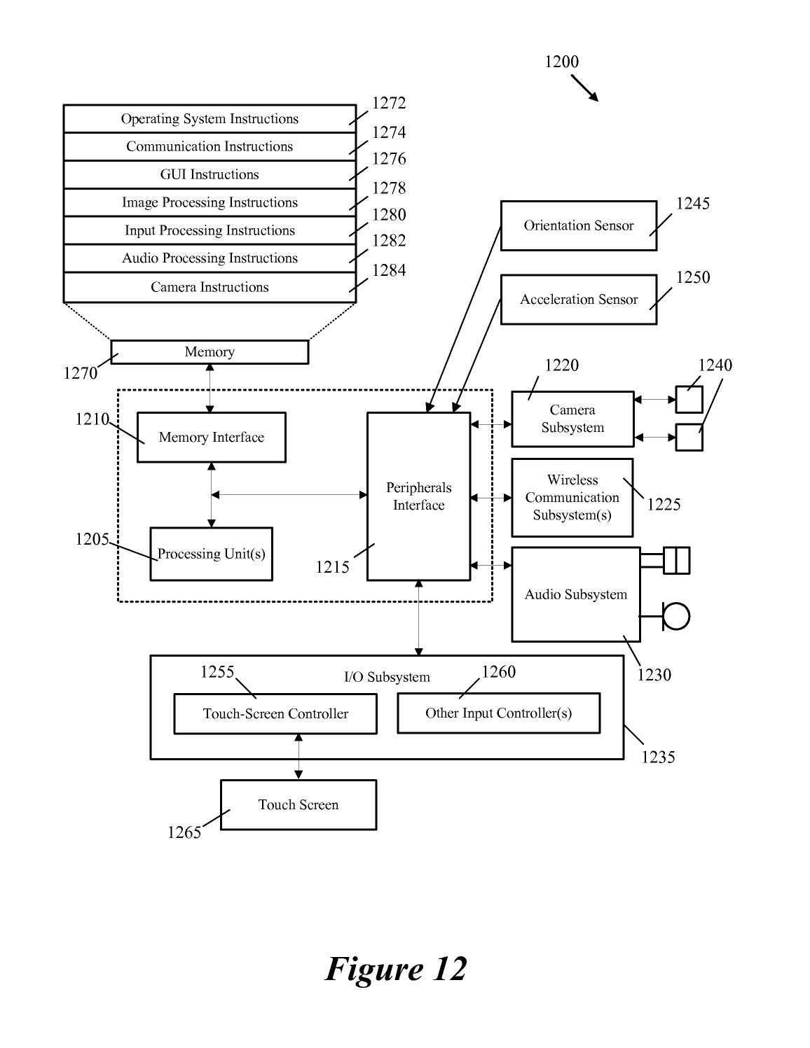

The image organizing, editing, and viewing applications of some embodiments operate on mobile devices, such as smartphones (e.g., iPhones®) and tablets (e.g., iPads®). FIG. 12 is an example of an architecture 1200 of such a mobile computing device. Examples of mobile computing devices include smartphones, tablets, laptops, etc. As shown, the mobile computing device 1200 includes one or more processing units 1205, a memory interface 1210 and a peripherals interface 1215.

The peripherals interface 1215 is coupled to various sensors and subsystems, including a camera subsystem 1220, a wireless communication subsystem(s) 1225, an audio subsystem 1230, an I/O subsystem 1235, etc. The peripherals interface 1215 enables communication between the processing units 1205 and various peripherals. For example, an orientation sensor 1245 (e.g., a gyroscope) and an acceleration sensor 1250 (e.g., an accelerometer) is coupled to the peripherals interface 1215 to facilitate orientation and acceleration functions.

The camera subsystem 1220 is coupled to one or more optical sensors 1240 (e.g., a charged coupled device (CCD) optical sensor, a complementary metal-oxide-semiconductor (CMOS) optical sensor, etc.). The camera subsystem 1220 coupled with the optical sensors 1240 facilitates camera functions, such as image and/or video data capturing. The wireless communication subsystem 1225 serves to facilitate communication functions. In some embodiments, the wireless communication subsystem 1225 includes radio frequency receivers and transmitters, and optical receivers and transmitters (not shown in FIG. 12). These receivers and transmitters of some embodiments are implemented to operate over one or more communication networks such as a GSM network, a Wi-Fi network, a Bluetooth network, etc. The audio subsystem 1230 is coupled to a speaker to output audio (e.g., to output voice navigation instructions). Additionally, the audio subsystem 1230 is coupled to a microphone to facilitate voice-enabled functions, such as voice recognition (e.g., for searching), digital recording, etc.

The I/O subsystem 1235 involves the transfer between input/output peripheral devices, such as a display, a touch screen, etc., and the data bus of the processing units 1205 through the peripherals interface 1215. The I/O subsystem 1235 includes a touch-screen controller 1255 and other input controllers 1260 to facilitate the transfer between input/output peripheral devices and the data bus of the processing units 1205. As shown, the touch-screen controller 1255 is coupled to a touch screen 1265. The touch-screen controller 1255 detects contact and movement on the touch screen 1265 using any of multiple touch sensitivity technologies. The other input controllers 1260 are coupled to other input/control devices, such as one or more buttons. Some embodiments include a near-touch sensitive screen and a corresponding controller that can detect near-touch interactions instead of or in addition to touch interactions.

The memory interface 1210 is coupled to memory 1270. In some embodiments, the memory 1270 includes volatile memory (e.g., high-speed random access memory), non-volatile memory (e.g., flash memory), a combination of volatile and non-volatile memory, and/or any other type of memory. As illustrated in FIG. 12, the memory 1270 stores an operating system (OS) 1272. The OS 1272 includes instructions for handling basic system services and for performing hardware dependent tasks.

The memory 1270 also includes communication instructions 1274 to facilitate communicating with one or more additional devices; graphical user interface instructions 1276 to facilitate graphic user interface processing; image processing instructions 1278 to facilitate image-related processing and functions; input processing instructions 1280 to facilitate input-related (e.g., touch input) processes and functions; audio processing instructions 1282 to facilitate audio-related processes and functions; and camera instructions 1284 to facilitate camera-related processes and functions. The instructions described above are merely exemplary and the memory 1270 includes additional and/or other instructions in some embodiments. For instance, the memory for a smartphone may include phone instructions to facilitate phone-related processes and functions. Additionally, the memory may include instructions for an image organizing, editing, and viewing application. The above-identified instructions need not be implemented as separate software programs or modules. Various functions of the mobile computing device can be implemented in hardware and/or in software, including in one or more signal processing and/or application specific integrated circuits.

While the components illustrated in FIG. 12 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 12 may be split into two or more integrated circuits.

### IV. Computer System

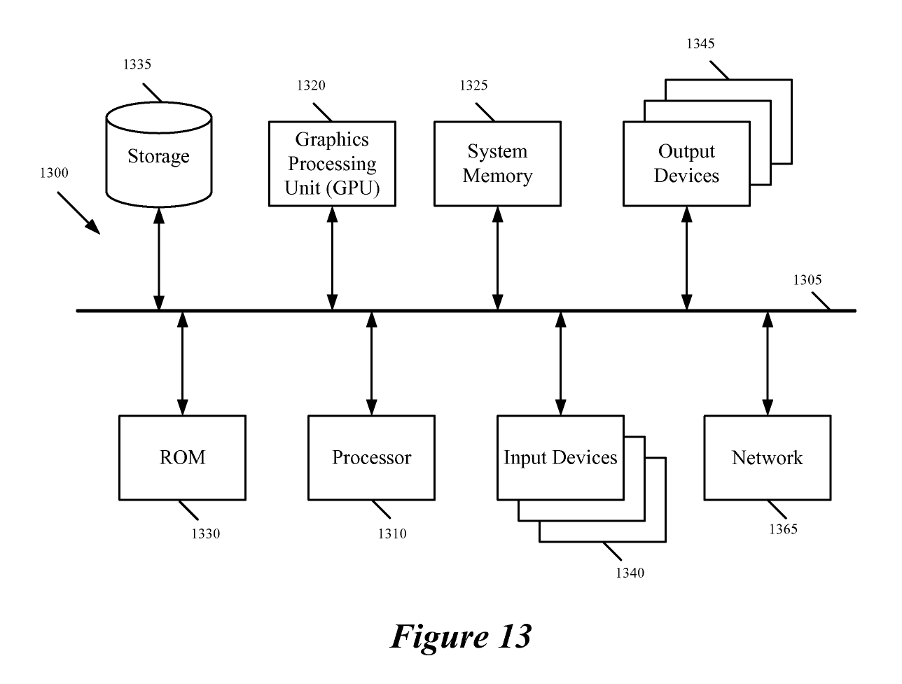

FIG. 13 conceptually illustrates another example of an electronic system 1300 with which some embodiments of the invention are implemented. The electronic system 1300 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 1300 includes a bus 1305, processing unit(s) 1310, a graphics processing unit (GPU) 1315, a system memory 1320, a network 1325, a read-only memory 1330, a permanent storage device 1335, input devices 1340, and output devices 1345.

The bus 1305 collectively represents all system, peripheral, and chipset buses that communicatively connect the numerous internal devices of the electronic system 1300. For instance, the bus 1305 communicatively connects the processing unit(s) 1310 with the read-only memory 1330, the GPU 1315, the system memory 1320, and the permanent storage device 1335.

From these various memory units, the processing unit(s) 1310 retrieves instructions to execute and data to process in order to execute the processes of the invention. The processing unit(s) may be a single processor or a multi-core processor in different embodiments. Some instructions are passed to and executed by the GPU 1315. The GPU 1315 can offload various computations or complement the image processing provided by the processing unit(s) 1310.

The read-only-memory (ROM) 1330 stores static data and instructions that are needed by the processing unit(s) 1310 and other modules of the electronic system. The permanent storage device 1335, on the other hand, is a read-and-write memory device. This device is a non-volatile memory unit that stores instructions and data even when the electronic system 1300 is off. Some embodiments of the invention use a mass-storage device (such as a magnetic or optical disk and its corresponding disk drive) as the permanent storage device 1335.

Other embodiments use a removable storage device (such as a floppy disk, flash memory device, etc., and its corresponding drive) as the permanent storage device. Like the permanent storage device 1335, the system memory 1320 is a read-and-write memory device. However, unlike storage device 1335, the system memory 1320 is a volatile read-and-write memory, such a random access memory. The system memory 1320 stores some of the instructions and data that the processor needs at runtime. In some embodiments, the invention's processes are stored in the system memory 1320, the permanent storage device 1335, and/or the read-only memory 1330. For example, the various memory units include instructions for processing multimedia clips in accordance with some embodiments. From these various memory units, the processing unit(s) 1310 retrieves instructions to execute and data to process in order to execute the processes of some embodiments.

The bus 1305 also connects to the input and output devices 1340 and 1345. The input devices 1340 enable the user to communicate information and select commands to the electronic system. The input devices 1340 include alphanumeric keyboards and pointing devices (also called “cursor control devices”), cameras (e.g., webcams), microphones or similar devices for receiving voice commands, etc. The output devices 1345 display images generated by the electronic system or otherwise output data. The output devices 1345 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 13, bus 1305 also couples electronic system 1300 to a network 1325 through a network adapter (not shown). In this manner, the computer can be a part of a network of computers (such as a local area network (“LAN”), a wide area network (“WAN”), or an Intranet, or a network of networks, such as the Internet. Any or all components of electronic system 1300 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While various processes described herein are shown with operations in a particular order, one of ordinary skill in the art will understand that in some embodiments the orders of operations will be different. For example in the process 400 of FIG. 4, the generation of the greenscreen image is shown as occurring after the loading of a source image. However, one of ordinary skill in the art will understand that in some embodiments a greenscreen image may have been previously generated and that greenscreen image will be loaded instead of a source image.

What is claimed is:

1. A method of adjusting an image, the method comprising:
receiving a source image that includes a first set of green pixels with a first set of color values and a second set of green pixels with a second set of color values;
generating a first greenscreen image by rendering the first set of green pixels transparent;
generating a second spill-suppressed color corrected greenscreen image by color adjusting the second set of green pixels;
generating an outline image by subtracting the second spill-suppressed color corrected greenscreen image from the first greenscreen image;
generating a third greenscreen image by selectively darkening pixels of the second spill-suppressed color corrected greenscreen image according to the brightness of corresponding pixels of the outline image.

2. The method of claim 1 further comprising, before generating the outline image, determining that the second spill-suppressed color corrected greenscreen image has dark edges.

3. The method of claim 2, wherein determining that the second spill-suppressed color corrected greenscreen image has dark edges comprises:
identifying edges of the second spill-suppressed color corrected greenscreen image by identifying a set of pixels next to transparent pixels of the second spill-suppressed color corrected greenscreen image; and
determining that a threshold fraction of the set of pixels is darker than a threshold brightness level.

4. The method of claim 3, wherein the threshold fraction is one-half.

5. The method of claim 1, wherein adjusting the second set of green pixels comprises adjusting a set of chroma values of the second set of pixels from green chroma values to gray chroma values.

6. The method of claim 5, wherein adjusting the second set of green pixels further comprises dimming the second set of pixels.

7. The method of claim 1, wherein the image is an image in a video clip.

8. A method of adjusting an image, the method comprising:
receiving a source image that includes a first set of pixels with a first set of color values and a second set of pixels with a second set of color values that is similar to the first set of color values;
generating a first chromakey image by rendering the first set of pixels transparent;
generating a second spill-suppressed color corrected chromakey image by color adjusting the second set of pixels;
generating an outline image by subtracting the second spill-suppressed color corrected chromakey image from the first chromakey image; and
generating a third chromakey image by selectively darkening pixels of the second spill-suppressed color corrected chromakey image according to the brightness of corresponding pixels of the outline image.

9. The method of claim 8 further comprising, before generating the outline image, determining that the second spill-suppressed color corrected chromakey image has dark edges.

10. The method of claim 9, wherein determining that the second spill-suppressed color corrected chromakey image has dark edges comprises:
identifying edges of the second spill-suppressed color corrected chromakey image by identifying a set of pixels next to transparent pixels of the second spill-suppressed color corrected chromakey image; and
determining that a threshold fraction of the set of pixels is darker than a threshold brightness level.

11. The method of claim 10, wherein the threshold fraction is one-half.

12. The method of claim 8, wherein adjusting the second set of pixels comprises adjusting a set of chroma values of the pixels from a set of chroma values of the second set of pixels to a set of gray chroma values.

13. The method of claim 12, wherein adjusting the second set of pixels further comprises dimming the second set of pixels.

14. The method of claim 8, wherein the image is an image in a video clip.

15. A device including a non-transitory machine readable medium storing a program for execution by at least one processor, the program comprising sets of instructions for:
receiving a single location-selection-and-motion command to select an irregularly shaped area of a source image;
identifying color values of pixels in the irregularly shaped area as selected color values; and
generating a chromakey image by rendering a set of pixels with the selected color values transparent.

16. The device of claim 15, wherein the location-selection-and motion command comprises a click-and-drag command received from a cursor control device.

17. The device of claim 15, wherein the location-selection-and motion command comprises a touch and drag command on a touch sensitive screen.

18. The device of claim 15, wherein the irregularly shaped area comprises a composite of a plurality of circular areas along a path of the location-selection-and-motion command.

19. The device of claim 15, wherein the set of pixels is a first set of pixels, wherein the set of instructions for generating a chromakey image further comprises a set of instructions for rendering a second set of pixels with color values close to the selected color values partially transparent.

20. The device of claim 15, wherein the set of pixels is a first set of pixels, wherein the set of instructions for generating a chromakey image further comprises a set of instructions for rendering a second set of pixels with color values between the selected color values completely transparent.
